(19) United States
(12) Patent Application Publication
(10) Pub. No.: US 2026/0099118 A1
(43) Pub. Date: Apr. 9, 2026

(54) IMAGE FORMING APPARATUS

(71) Applicant: CANON KABUSHIKI KAISHA, Tokyo (JP)

(72) Inventors: TAKENORI SUEOKA, Ibaraki (JP); SHOHEI OKUMURA, Tokyo (JP); AKIHITO YOKOTE, Chiba (JP); MIREI AOYAMA, Chiba (JP); HIROAKI ISHIDA, Tokyo (JP); TATSUOMI MURAYAMA, Chiba (JP); TADASHI FUKUDA, Tokyo (JP)

(21) Appl. No.: 19/349,275

(22) Filed: Oct. 3, 2025

(30) Foreign Application Priority Data
Oct. 4, 2024 (JP) 2024-175260
Sep. 18, 2025 (JP) 2025-154767

(51) Int. Cl. G03G 15/00; G03G 15/01

(52) U.S. Cl. CPC G03G 15/5062; G03G 15/0189; G03G 15/6573; G03G 2215/00755; G03G 2215/0164

(57) ABSTRACT

An image forming apparatus includes an image forming unit configured to form an image, a conveyance unit configured to convey a sheet on which a test image has been formed, a sensor configured to read the test image on the sheet, while the sheet is being conveyed by the conveyance unit, and a controller. The controller causes the image forming unit to form a test image on each of a first sheet and a second sheet succeeding the first sheet, and based on a reading result of the test image on the first sheet read by the sensor and a reading result of the test image on the second sheet read by the sensor, suppresses density unevenness, in a conveyance direction in which the sheet is conveyed, of the image to be formed by the image forming unit.

### BACKGROUND

### Field of the Technology

The present disclosure relates to an electrophotographic image forming apparatus.

### Description of the Related Art

In electrophotographic image forming apparatuses, density unevenness may occur in output images due to various causes in the image forming process (e.g. unevenness of sensitivity of a photosensitive drum, unevenness of exposure by an exposure device, etc.). As a technique for correcting such density unevenness in output images, a technique for correcting density unevenness in output images based on density detected using a detection pattern is known.

image forming apparatus described in Japanese Patent Laid-Open No. 2000-98675 detects the rotation cycle of a developing roller, detects density unevenness of a pattern formed on an image carrier, and controls development bias so as to align the phase of the detection signal of the density unevenness and the detection signal of the developing roller rotation cycle. With this, density unevenness in the sub-scanning direction occurring in toner images on an image carrier is corrected.

In a detection result of a test pattern for detecting density unevenness, noise due to the sheet on which the test pattern is formed ends up being superimposed. With this, the accuracy of detecting density unevenness occurring due to an image carrier (photosensitive member) decreases, and the accuracy of correction in density unevenness correction processing performed based on the detection result may decrease.

### SUMMARY

The present disclosure provides a technique for improving correction accuracy in correction processing for correcting density unevenness in the sub-scanning direction occurring in an output image.

According to one aspect of the present disclosure, there is provided an image forming apparatus comprising: an image forming unit configured to form an image; a conveyance unit configured to convey a sheet on which a test image has been formed by the image forming unit; a sensor configured to read the test image on the sheet, while the sheet is being conveyed by the conveyance unit; and a controller configured to: cause the image forming unit to form a test image on each of a first sheet and a second sheet succeeding the first sheet; and based on a reading result of the test image on the first sheet read by the sensor and a reading result of the test image on the second sheet read by the sensor, suppress density unevenness, in a conveyance direction in which the sheet is conveyed, of the image to be formed by the image forming unit.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view illustrating an example of a hardware configuration of an image forming apparatus.

FIG. 2 is a block diagram illustrating an example of a control configuration of an image forming apparatus 100.

FIG. 3 illustrates an example of a conversion table for converting luminance values to density values.

FIG. 4 is a flowchart illustrating an example of a procedure for density unevenness correction processing.

FIG. 5 illustrates an example of a test pattern outputted onto a sheet.

FIGS. 6A and 6B illustrate examples of setting a sheet interval for an image forming operation.

FIGS. 7A and 7B illustrate examples of setting regions in the sub-scanning direction for density unevenness detection.

FIGS. 8A and 8B illustrate examples of setting a sheet interval for an image forming operation (second embodiment).

FIGS. 9A and 9B illustrate examples of setting a sheet interval for an image forming operation (third embodiment).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Image Forming Apparatus

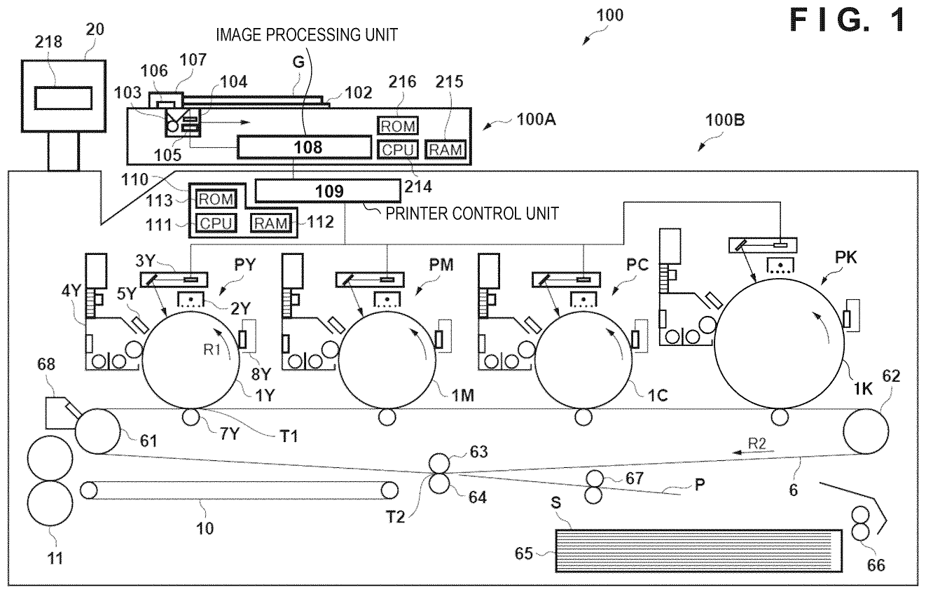

FIG. 1 is a cross-sectional view illustrating an example of a hardware configuration of an image forming apparatus according to an embodiment of the present disclosure. An image forming apparatus 100 includes an operation unit 20, an image reading unit (reader unit) 100A for reading an image of a document G, and a printer unit 100B for forming an image based on image data. The operation unit 20 includes a display unit 218. The operation unit 20 is connected to a control unit 110 and the image reading unit 100A. The operation unit 20 is used to accept operations by a user.

The image forming apparatus 100 is a color laser printer that forms images using yellow (Y), magenta (M), cyan (C), and black (K) developers (toners). The image forming apparatus 100 may be configured as any of a printing apparatus, a printer, a copier, a multi-function peripheral (MFP), or a facsimile device, for example. The suffixes Y, M, C, and K in the reference numerals indicate that the colors of developers (toners) targeted by corresponding members are yellow, magenta, cyan, and black, respectively. In the following description, when it is not necessary to distinguish colors, reference numerals without the suffixes Y, M, C, and K are used.

The image forming apparatus 100 includes four image forming units P (image forming units PY, PM, PC, and PK) for respectively forming images using toners of different colors (Y, M, C, and K). The image forming units PY, PM, PC, and PK are included in the printer unit 100B. As illustrated in FIG. 1, the image forming apparatus 100 is configured as a tandem intermediate transfer color printer in which the image forming units PY, PM, PC, and PK are arranged in order along the moving direction of an intermediate transfer belt 6. The image forming units PY, PM, PC, and PK adopt the same configuration, except for differences in the toner colors used by developing apparatuses 4Y, 4M, 4C, and 4K and a difference in the outer diameter of a photosensitive drum 1K compared to the outer diameter of photosensitive drums 1Y, 1M, and 1C. For example, the photosensitive drum 1K is configured with a photosensitive drum having an outer diameter of 80 mm, and the photosensitive drums 1Y, 1M, and 1C are configured with photosensitive drums having an outer diameter of 40 mm. In FIG. 1, for simplification, reference numerals for some components of the image forming units PM, PC, and PK corresponding to M, C, and K are not denoted.

### Reader Unit

A reader unit 100A includes a document table 102 on which a document G is placed. To read an image of the document G on the document table 102, the reader unit 100A includes a light source 103, an optical system 104, and a reading sensor 105. The light source 103 irradiates light onto the document G. The irradiated light is reflected by the document G. The optical system 104 includes lenses and the like, and forms an image of the light reflected from the document G onto the light receiving surface of the reading sensor 105. The reading sensor 105 is, for example, a Charge-Coupled Device (CCD) sensor, and receives the reflected light imaged on the light receiving surface. The reader unit 100A generates image data representing the image of the document G in accordance with the reflected light received by the reading sensor 105, and transmits the generated image data to the printer unit B. The light source 103, the optical system 104, and the reading sensor 105 are integrally configured as a reading unit, and move in the direction of an arrow illustrated in FIG. 1. With this, the entire image of the document G is read by the reading sensor 105.

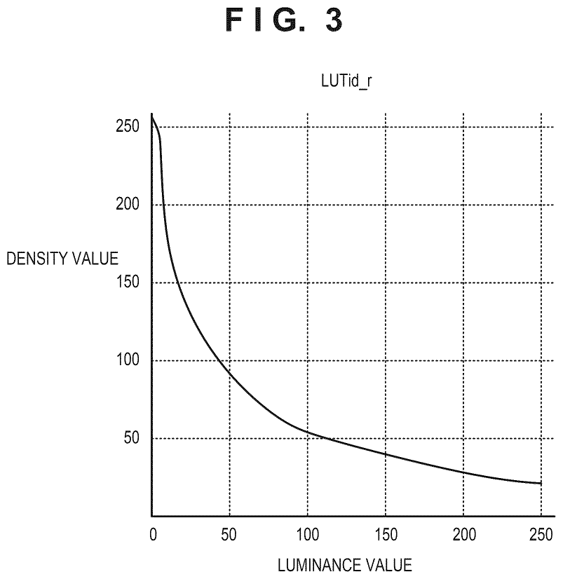

The reading sensor 105 outputs a luminance value corresponding to the received reflected light. This luminance value is converted into a density value by an image processing unit 108 using a predetermined conversion table for converting luminance values to density values. FIG. 3 illustrates an example of a conversion table (LUTid_r) for converting luminance values to density values. The conversion table LUTid_r is a table that associates luminance values with corresponding density values, and is configured to output, for example, 8-bit density values.

### Printer Unit

The printer unit 100B forms an image based on the image data generated by the reader unit 100A. The printer unit 100B can also form an image based on image data received from an external device via a network or a telephone line.

The printer unit 100B includes the control unit 110 for controlling the overall operation of the image forming apparatus 100. The control unit 110 includes a CPU 111, a RAM 112, and a ROM 113. The printer unit 100B further includes a printer control unit 109 that controls the image forming operation (printing operation) performed using the image forming units PY, PM, PC, and PK.

An image forming unit P includes a photosensitive drum 1 (photosensitive member), and a charging apparatus (charging unit) 2, an exposure apparatus (exposure unit) 3, a developing apparatus (developing unit) 4, a potential sensor 5, a primary transfer roller 7, and a cleaning apparatus 8, which are arranged around the photosensitive drum 1. The photosensitive drum 1 rotates in the direction of arrow R1. The charging apparatus 2 charges the surface of the photosensitive drum 1 to a predetermined potential.

The exposure apparatus 3 emits laser light (light beam) based on an input image signal (input image data), and exposes the photosensitive drum 1 by scanning the surface of the photosensitive drum 1 with the laser light. With this, an electrostatic latent image is formed on the photosensitive drum 1 based on the input image data. The exposure apparatus 3 includes a rotating polygon mirror for scanning the laser light. The polygon mirror, by having laser light irradiated onto one of its plurality of reflective surfaces, deflects the laser light such that the laser light scans the surface of the photosensitive drum 1.

The developing apparatus 4 develops the electrostatic latent image on the photosensitive drum 1 by adhering toner to the electrostatic latent image. With this, a toner image is formed on the photosensitive drum 1. The potential sensor 5 is provided near the photosensitive drum 1, between the position of exposure by the exposure apparatus 3 and the developing apparatus 4. The potential sensor 5 can detect the potential of the electrostatic latent image formed on the photosensitive drum 1. In the present embodiment, the exposure apparatus 3 is an example of an exposure unit that forms an electrostatic latent image on a photosensitive member (photosensitive drum 1) by exposing the photosensitive member with laser light based on image data. In addition, the developing apparatus 4 is an example of a developing unit that forms a toner image to be transferred to a sheet by developing the electrostatic latent image formed on the photosensitive member with toner. The image forming unit P is an example of an image forming unit configured to form an image, and forms an electrostatic latent image on a cylindrical photosensitive member while rotating the photosensitive member, and develops the electrostatic latent image on the photosensitive member.

The primary transfer roller 7 presses the inner surface of the intermediate transfer belt 6 to form a primary transfer nip portion T1 between the photosensitive drum 1 and the intermediate transfer belt 6. The primary transfer roller 7 transfers the toner image on the photosensitive drum 1 to the intermediate transfer belt 6 by a transfer bias voltage being applied. The cleaning apparatus 8 collects toner remaining on the photosensitive drum 1 after the toner image has been transferred to the intermediate transfer belt 6.

The four-color toner images respectively formed on the photosensitive drums 1Y, 1M, 1C, and 1K in the image forming units PY, PM, PC, and PK are sequentially transferred in an overlapping manner onto the intermediate transfer belt 6 (primary transfer). With this, a multi-color toner image composed of Y, M, C, and K is formed on the intermediate transfer belt 6.

The intermediate transfer belt 6 is supported by a tension roller 61, a drive roller 62, and an opposing roller 63, and is driven by the drive roller 62 to rotate in the direction of arrow R2 at a predetermined speed. The toner image formed on the intermediate transfer belt 6 is conveyed to a secondary transfer nip portion T2 between the intermediate transfer belt 6 and a secondary transfer roller 64, with the rotation of the intermediate transfer belt 6. The toner image on the intermediate transfer belt 6 is transferred to a sheet S by a secondary transfer roller 64. The cleaning apparatus 8 collects toner remaining on the intermediate transfer belt 6 from the intermediate transfer belt 6 after the toner image has been transferred to the sheet S.

The sheet S is fed and conveyed from a paper feed cassette 65 in accordance with the timing at which the toner image on the intermediate transfer belt 6 arrives at the secondary transfer nip portion T2. The sheet S may be referred to as recording paper, recording material, recording medium, sheet, transfer material, transfer paper, etc. The sheets S are separated one by one by separation rollers 66, fed into a conveyance path, and conveyed along the conveyance path toward a registration roller pair 67. The registration roller pair 67 is driven so as to cause the sheet S on the conveyance path to wait in a stopped state and feed the sheet S to the secondary transfer nip portion T2 in accordance with the timing at which the toner image on the intermediate transfer belt 6 is conveyed. With this, the toner image on the intermediate transfer belt 6 is transferred (secondary transfer) to the sheet S at the secondary transfer nip portion T2.

The sheet S to which the toner image has been transferred is conveyed to a fixing apparatus 11. The fixing apparatus 11 fixes the toner image transferred onto the sheet S to the sheet S by applying heat and pressure to the toner image. After fixing processing by the fixing apparatus 11, the sheet S is discharged to the outside of the image forming apparatus 100 (e.g., to an output tray).

### Control Configuration

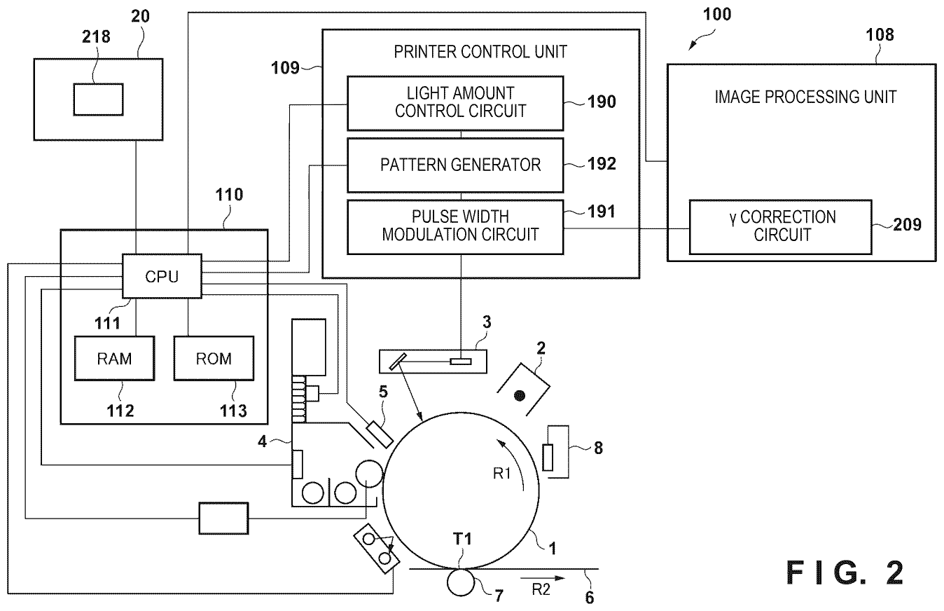

FIG. 2 is a block diagram illustrating an example of a control configuration of the image forming apparatus 100. The printer control unit 109 includes a light amount control circuit 190, a pulse width modulation circuit 191, and a pattern generator 192. The image processing unit 108 includes a γ correction circuit 209.

The light amount control circuit 190 controls the light amount (power) of laser light outputted from the exposure apparatus 3. The light amount control circuit 190 determines the light amount of laser light outputted from the exposure apparatus 3 so as to obtain a desired image density for a laser drive signal. The light amount of laser light corresponds to the exposure amount of the exposure apparatus 3 and is an example of an image forming condition. The pattern generator 192 holds image data for forming a test pattern (test image), which is a density measurement pattern image to be described later.

The γ correction circuit 209 converts an input image signal (input value) included in inputted image data into an output image signal (output value) by referencing a tone correction table (LUT). The tone correction table is a conversion table for converting image data to correct the tone characteristics of an image formed by an image forming unit P. A correspondence between an output image signal and a density level is obtained in advance and stored in the ROM 113. The tone correction table, which has been generated based on this correspondence, is stored in the γ correction circuit 209.

The pulse width modulation circuit 191 generates a laser drive signal based on the light amount determined by the light amount control circuit 190 and the image signal converted based on the tone correction table and outputted from the γ correction circuit 209. The laser drive signal is a pulse width modulation (PWM) signal and is used to modulate the laser light outputted from the exposure device. The pulse width modulation circuit 191 outputs, for each pixel, a pulse signal with a pulse width (time width) corresponding to a density indicated by the inputted image signal, as the laser drive signal. The laser drive signal has a wide pulse width for high density pixels, a narrow pulse width for low density pixels, and a medium pulse width for medium density pixels.

The exposure apparatus 3 forms an image (electrostatic latent image) on the photosensitive drum 1 with tones expressed by area tones in accordance with the pulse width of the laser drive signal. Specifically, the laser light source (semiconductor laser) of the exposure apparatus 3 emits light for a time corresponding to the pulse width of the supplied laser drive signal. The laser light source is driven for a longer time, the higher the density of the pixel to be formed is, and is driven for a shorter time, the lower the density of the pixel to be formed is. As a result, the dot size (area) of the electrostatic latent image formed on the photosensitive drum 1 becomes a different size in accordance with the density of the pixel. That is, the exposure apparatus 3 exposes a longer range in the main scanning direction for high density pixels, and exposes a shorter range in the main scanning direction for low density pixels. In the present embodiment, the main scanning direction is a direction orthogonal to the sheet conveyance direction, and the sub-scanning direction (rotation direction of the photosensitive member) is the sheet conveyance direction (a direction orthogonal to the main scanning direction).

In the present embodiment, the control unit 110 (CPU 111) obtains measurement data indicating a result of measurement of density of a test pattern by the reader unit 100A and performs processing based on the measurement data. Here, the measurement data is information (density data) on density detected at a plurality of positions in the sub-scanning direction of the test pattern. The control unit 110 (CPU 111) further controls formation of a density unevenness correction test pattern by the printer unit 100B and correction of the exposure amount of the exposure apparatus 3 in image formation by the printer unit 100B.

### Shading Function

The image forming apparatus 100 of the present embodiment realizes correction of density unevenness in the sub-scanning direction (sheet conveyance direction) occurring in an image (output image) formed by the printer unit 100B by using a shading function included in the exposure apparatus 3. The exposure apparatus 3 can adjust the light amount (exposure amount) of laser light outputted from the laser light source during one scanning cycle by using the shading function. By adjusting (correcting) the light amount of laser light during one scanning cycle in accordance with density unevenness occurring in an output image, density unevenness correction is possible. By adjusting (correcting) the light amount of laser light, not only density unevenness in the sub-scanning direction but also density unevenness in the main scanning direction (a direction orthogonal to the sheet conveyance direction) can be corrected.

In the image forming apparatus 100 of the present embodiment, an image forming region in the sub-scanning direction where the image is formed is divided into a plurality of regions at equal intervals in the sub-scanning direction, and a light amount setting (LPW) of the exposure apparatus 3 is managed for each divided region. A correction amount (exposure correction amount ΔLPW) of the light amount of laser light used in density unevenness correction is generated and managed by correction processing, which will be described later. In the present embodiment, the correction amount is managed in units of regions with a predetermined width (e.g., about 12.5 mm) in the sub-scanning direction.

### Density Unevenness Correction Processing

Next, correction processing for correcting density unevenness in the sub-scanning direction occurring in an image (output image) formed by the printer unit 100B in the present embodiment will be described. This correction processing is executed by the control unit 110 in the image forming apparatus 100 of the present embodiment.

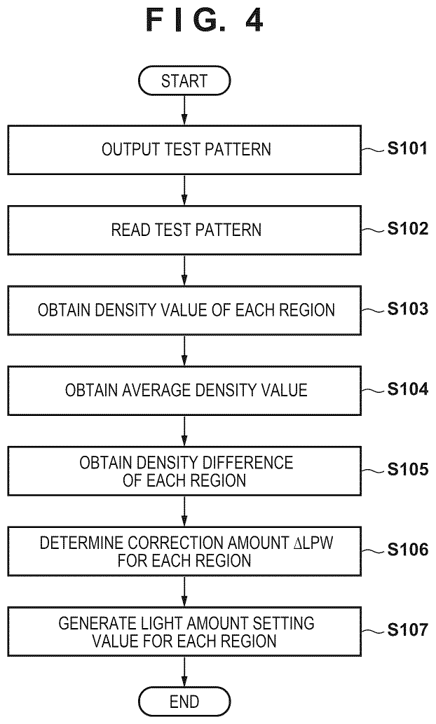

FIG. 4 is a flowchart illustrating a procedure for density unevenness correction processing. When the control unit 110 starts executing the density unevenness correction processing, first in step S101, the control unit 110 controls the image forming units P to form (output) a test pattern that includes images for detecting density unevenness in the sub-scanning direction occurring in output images on a sheet S.

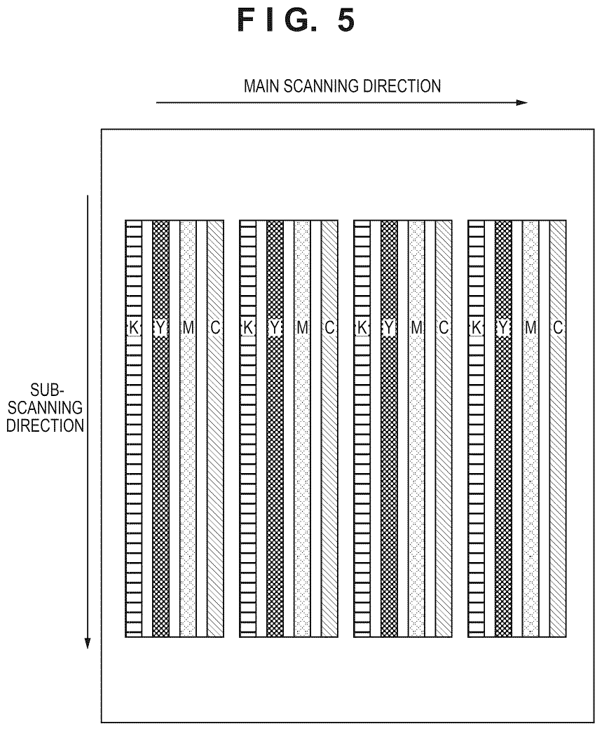

FIG. 5 is a diagram illustrating an example of the test pattern outputted in step S101. As illustrated in FIG. 5, the test pattern of the present embodiment is composed of an image pattern including, as detection images, a plurality of band images (rectangular images), each having a fixed width in the main scanning direction and in which the sub-scanning direction is the longitudinal direction. These plurality of band images (detection images) are each formed across the image forming region in the sub-scanning direction based on a uniform image signal value, and are arranged in parallel in the main scanning direction orthogonal to the sub-scanning direction. Therefore, each band image is formed (output) as an image with uniform density if no density unevenness occurs. In the present embodiment, as an example, each band image is formed with an image signal value of 40% (i.e., an image signal value indicating a density level of 40% relative to the maximum density level). In addition, in the test pattern illustrated in FIG. 5, band image groups, each composed of band images of different colors (Y, M, C, and K) are arranged at different positions in the main scanning direction.

In the present embodiment, the control unit 110 performs phase control to control the phase (rotation phase) of a photosensitive drum 1 when outputting the test pattern to a sheet S. In this phase control, the phase of the photosensitive drum 1 is controlled so that the writing start position of the test pattern in the sub-scanning direction aligns with the home position of the phase of the photosensitive drum 1, which is a rotating member that causes density unevenness occurring in an output image. With this, density data can be obtained in association with the phase of the photosensitive drum 1 for each of Y, M, C, and K colors.

Periodic changes (density unevenness) that appear in density data due to the photosensitive drum 1 occur periodically in the sub-scanning direction in synchronization with the rotation cycle of the photosensitive drum 1. For example, for a photosensitive drum with an outer diameter of 40 mm (photosensitive drums 1Y, 1M, and 1C), when the test pattern is formed on one A3-sized sheet, a detection result corresponding to three cycles of density unevenness can be obtained. Meanwhile, for a photosensitive drum with an outer diameter of 80 mm (photosensitive drum 1K), when the test pattern is formed on one A3-sized sheet, only a detection result corresponding to one cycle of density unevenness can be obtained. Therefore, the control unit 110 outputs the test pattern on a plurality of sheets to obtain density data such that a detection result corresponding to a plurality of cycles of density unevenness can be obtained not only for the photosensitive drums 1Y, 1M, and 1C but also for the photosensitive drum 1K.

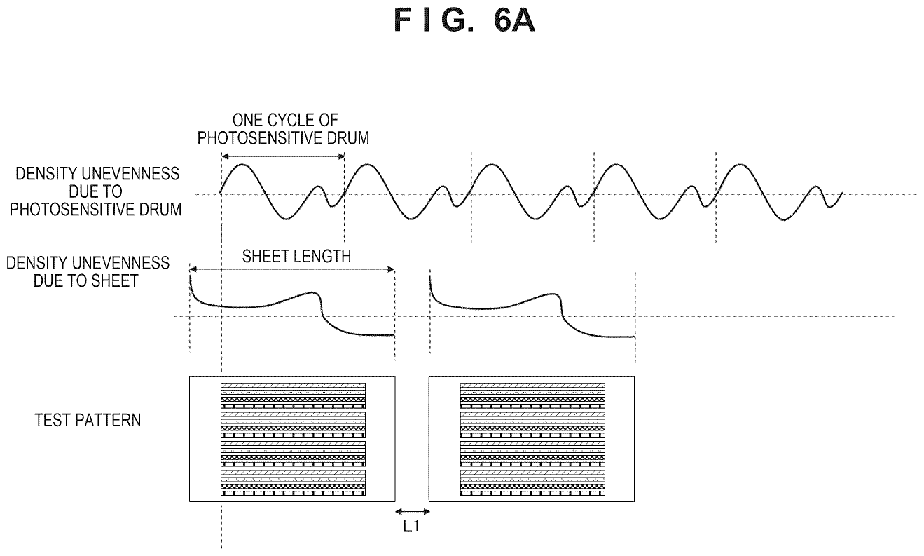

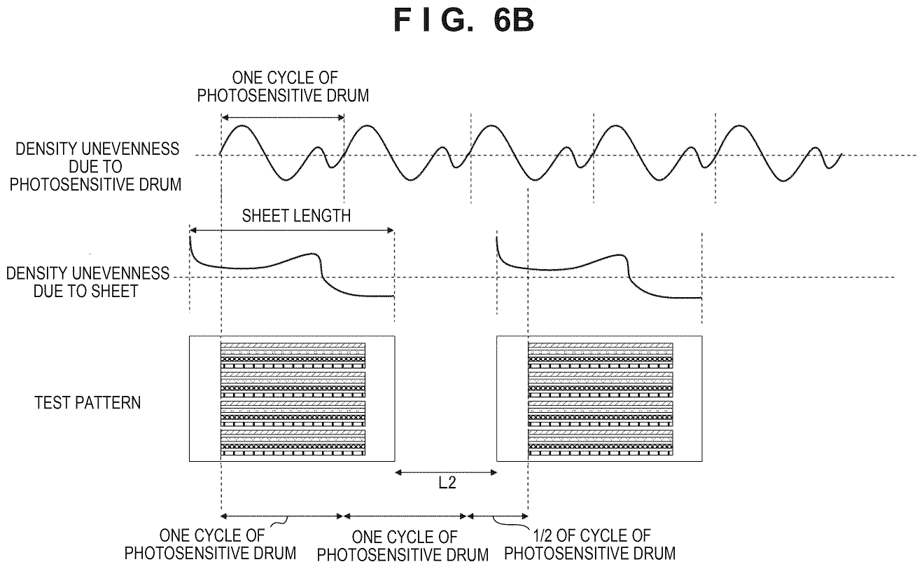

In the present embodiment, the control unit 110 sets a sheet interval (distance) between a preceding sheet (first sheet) and a next sheet (second sheet succeeding the first sheet), used when forming images on a plurality of sheets S in an image forming operation for forming the test pattern, to a sheet interval different from a sheet interval in a normal image forming operation. In the following, a case where the test pattern is formed on an A3 sheet S will be described. FIG. 6A illustrates an example in which a sheet interval L1 set in a normal image forming operation for forming images (other than the test pattern) based on input image data is used as a sheet interval for an image forming operation. In a normal image forming operation, for example, to improve image forming speed (printing speed), the sheet interval L1 is set to as short an interval as possible.

Periodic changes occur in the density data of the test pattern. The phase of this density data should match the rotation phase of the rotating member (photosensitive drum 1), but in reality, it includes noise due to the sheet. Therefore, a combination of periodic changes (noise) due to the sheet and periodic changes (density unevenness) due to the photosensitive drum 1 appear in the density data of the test pattern. FIGS. 6A and 6B are schematic diagrams illustrating density data obtained from a black test pattern. As illustrated in FIG. 6A, when the test pattern is formed on a plurality of sheets S with the same sheet interval as the sheet interval L1 in a normal image forming operation, the phase of periodic changes (noise) appearing in density data due to the sheet may become close to the phase of periodic changes (density unevenness) appearing in density data due to the photosensitive drum 1K. Causes of periodic changes (noise) in density data due to the sheet S include, for example, shocks occurring when the sheet S enters or exits the secondary transfer portion T2, and shocks occurring when the sheet S passes through the registration rollers 67. The causes also include toner scattering, smudging, or the like due to changes in the orientation of the sheet S in the secondary transfer portion T2 caused by changes in the contact orientation between the sheet S and its conveyance guide (not illustrated). Density unevenness in the sub-scanning direction due to the sheet S can occur at the same sub-scanning position (position on the sheet in the sub-scanning direction) even for different sheets.

When periodic changes (noise) appearing in density data due to the sheet S are superimposed, in a nearly in-phase state, on periodic changes (density unevenness) appearing in density data due to the photosensitive drum 1K, even if detection results of density unevenness corresponding to different rotation cycles of the photosensitive drum 1K are averaged, the influence of periodic changes appearing in density data due to the sheet S cannot be reduced. As a result, excess or deficiency may occur in a correction amount used in the correction processing performed based on the obtained detection results, and correction accuracy may decrease.

Therefore, the control unit 110 sets a sheet interval L2 in the image forming operation for forming the test pattern, taking into account the rotation cycle of the photosensitive drum 1K, to an interval different from the sheet interval L1 in a normal image forming operation, and forms the test pattern on a plurality of sheets S. FIG. 6B illustrates an example of the sheet interval L2 set in the image forming operation for forming the test pattern on a plurality of sheets S (two sheets S).

The control unit 110 controls the sheet interval L2 (FIG. 6B) in the image forming operation for forming the test pattern such that its interval differs from the sheet interval L1 (FIG. 6A) in a normal image forming operation. The control of the sheet interval L2 involves control of the writing start position of the test pattern formed on the sheets S and conveyance control of the sheets S accordingly. In this example, the control unit 110 controls the sheet interval L2 such that an interval between the writing start position of the test pattern formed on a preceding sheet S and the writing start position of the test pattern formed on a next sheet S in the sub-scanning direction equals a sum of an integer multiple of the circumference of the photosensitive drum 1K and ½ of that circumference (for example, such that the interval is included in a range that is ±2.5% relative to that sum).

With this, as illustrated in FIG. 6B, the phase of periodic changes (noise) appearing in density data due to the sheet S can be reliably shifted from the phase of periodic changes (density unevenness) appearing in density data due to the photosensitive drum 1K. In this state, for example, averaging processing for averaging a detection result of density unevenness corresponding to a phase corresponding to one rotation cycle of the photosensitive drum obtained from the first sheet S and a detection result of density unevenness corresponding to a phase corresponding to one rotation cycle of the photosensitive drum obtained from the second sheet S is performed. With this averaging processing, the influence of periodic changes (noise) appearing in density data due to the sheet S can be reduced (or suppressed). As a result, the detection accuracy of periodic changes (density unevenness) appearing in density data due to the photosensitive drum 1K can be improved.

As described above, the image forming apparatus 100 includes a plurality of photosensitive drums 1 with different outer diameters, and includes the photosensitive drums 1Y, 1M, and 1C (first photosensitive members) and the photosensitive drum 1K (second photosensitive member) with a larger outer diameter than the photosensitive drums 1Y, 1M, and 1C. In the present embodiment, the control unit 110 uses the circumference of the photosensitive drum 1K with a larger outer diameter to control the sheet interval L2 in the image forming operation for forming the test pattern. For the photosensitive drums 1Y, 1M, and 1C, a detection result for density unevenness corresponding to a plurality of rotation cycles of the photosensitive drum can be obtained by reading the test pattern formed on one sheet. By averaging the detection results of density unevenness across a plurality of rotation cycles of the photosensitive drums 1Y, 1M, and 1C, the influence of periodic changes (noise) appearing in density data due to the sheet S can be reduced.

In contrast, for the photosensitive drum 1K with a larger outer diameter, only a detection result for density unevenness corresponding to one rotation cycle of the photosensitive drum can be obtained by reading the test pattern formed on one sheet. Therefore, it is necessary to output the test pattern on a plurality of sheets and obtain density data. In that case, as described above, the control unit 110 of the present embodiment controls the sheet interval L2 in the image forming operation for forming the test pattern, with the photosensitive drum 1K as the target, such that the influence of periodic changes (noise) appearing in density data due to the sheet S can be reduced.

After the test pattern is formed on the sheet S in step S101, next in step S102, the control unit 110 reads the test pattern by using the reader unit 100A and obtains corresponding image data. The pixel value of each pixel in the obtained image data is expressed as a luminance value. Here, the control unit 110 divides the image forming region in the sub-scanning direction (conveyance direction of the sheet S) into a plurality of regions, and obtains a detection result (luminance values) of density of the test pattern for each region, in units of divided regions.

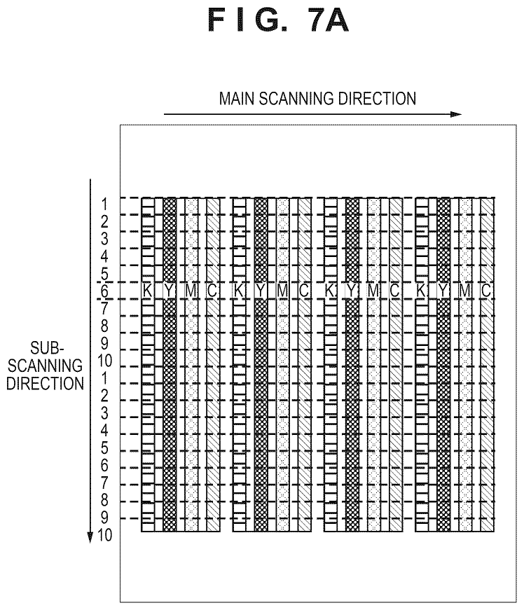

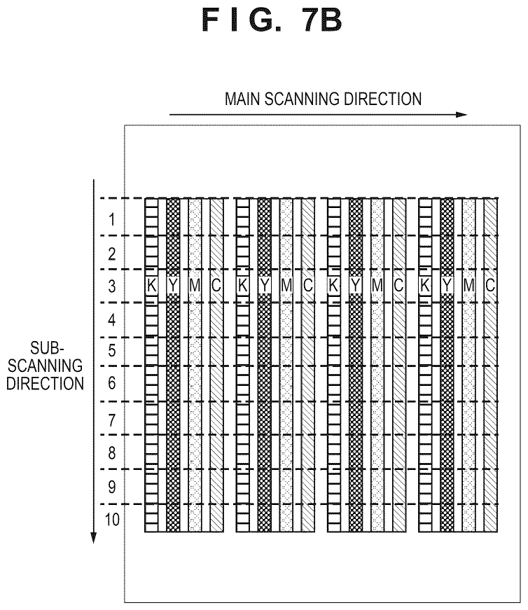

In this example, as illustrated in FIG. 6B, the control unit 110 forms the test pattern on two sheets S and performs processing for correcting density unevenness in the sub-scanning direction occurring in an output image based on the reading results of the test patterns. FIG. 7A illustrates an example of setting regions in the sub-scanning direction for detecting density unevenness for the photosensitive drums 1Y, 1M, and 1C (outer diameter=40 mm). In this example, the image forming region in the sub-scanning direction with a length (e.g., 126 mm) greater than or equal to the circumference of the photosensitive drum 1 is divided into 10 regions at equal intervals (e.g., about 12.6-mm intervals), and a detection result of density for each region is obtained in units of divided region. In addition, for each sheet S, a detection result of density corresponding to two rotation cycles of the photosensitive drum 1 is obtained based on the formed test pattern.

Meanwhile, FIG. 7B illustrates an example of setting regions in the sub-scanning direction for detecting density unevenness for the photosensitive drum 1K (outer diameter=80 mm). In this example, the image forming region in the sub-scanning direction with a length (e.g., 252 mm) greater than or equal to the circumference of the photosensitive drum 1K is divided into 10 regions at equal intervals (e.g., about 25.2-mm intervals), and a detection result of density for each region is obtained in units of divided region. In addition, for each sheet S, a detection result of density corresponding to one rotation cycle of the photosensitive drum 1K is obtained based on the formed test pattern.

Next, in step S103, the control unit 110 converts the luminance values included in image data for each region in the sub-scanning direction obtained in step S102 into density values (reading values). The conversion from luminance values to density values is performed using the conversion table exemplified in FIG. 3. After conversion to density values, in step S104 the control unit 110, for each rotation cycle of the photosensitive drum 1, averages density values (reading values) of a corresponding plurality of regions and obtains an average density value. Further, in step S105, the control unit 110 obtains, for each rotation cycle of the photosensitive drum 1, the average density value of a plurality of regions and a density difference ΔD, which is a difference between the density value of each region and the average density value.

Then, in step S106, the control unit 110 determines exposure correction amounts ΔLPW corresponding to the respective density differences ΔD of the plurality of regions obtained in step S105. Further, in step S107, the control unit 110 averages ΔLPW obtained for each rotation cycle of the photosensitive drum 1 across a plurality of rotation cycles, and thereby aims to reduce the influence of periodic changes (noise) appearing in density data due to the sheet S. In this way, the control unit 110 obtains reading results of the test pattern for each rotation cycle of the photosensitive drum 1, averages the obtained reading results across a plurality of rotation cycles of the photosensitive drum 1, and determines exposure correction amounts corresponding to respective regions in the sub-scanning direction (conveyance direction) based on the averaged reading result. Note that the exposure correction amounts are examples of a control parameter for suppressing the density unevenness, generated based on an average for each of the plurality of regions, which is determined from the first reading value and the second reading value.

Finally, in step S107, the control unit 110 corrects the exposure amount of the exposure apparatus 3 based on the respective exposure correction amounts ΔLPW of the plurality of regions in the sub-scanning direction, and thereby corrects density unevenness in an output image in the sub-scanning direction. Specifically, the control unit 110 generates respective light amount setting values (LPW) of the plurality of regions by correcting the light amount setting values set as the latest image forming condition using the exposure correction amounts ΔLPW for respective regions. The generated light amount setting values (LPW) are applied to the light amount control circuit 190. With this, laser light for exposing the photosensitive drum 1 is outputted from the exposure apparatus 3 with the light amount (power) corresponding to the light amount setting values (LPW). As a result, density unevenness of an output image in the sub-scanning direction is corrected. When the processing in step S107 is completed, the control unit 110 completes the processing according to the procedure in FIG. 4.

As described above, in the image forming apparatus 100 of the present embodiment, the control unit 110 causes the image forming units P to form, on a sheet, a test pattern (test image) that includes detection images for detecting density unevenness in the conveyance direction (sub-scanning direction) occurring in an image formed on a sheet S. The control unit 110 determines exposure correction amounts corresponding to respective regions in the conveyance direction based on a reading result of the detection images, and corrects the exposure amount of the exposure apparatus 3 based on the exposure correction amounts corresponding to respective regions in the conveyance direction. The control unit 110 sets a sheet interval between a preceding sheet and a next sheet, used when forming images on a plurality of sheets conveyed in the conveyance direction, to a first sheet interval in a normal image forming operation and to a second sheet interval different from the first sheet interval in the image forming operation for forming the test pattern.

With this, when forming the test pattern on a plurality of sheets S, the phase of periodic changes (noise) appearing in density data due to the sheet S can be shifted from the phase of periodic changes (density unevenness) appearing in density data due to the photosensitive drum 1. Therefore, it is possible to prevent periodic changes (noise) appearing in density data due to the sheet S from being superimposed, in an in-phase or nearly in-phase state, on periodic changes (density unevenness) appearing in density data due to the photosensitive drum 1 detected by reading the test pattern (detection image). As a result, a decrease in the accuracy of detecting density unevenness occurring due to the photosensitive drum 1 caused by the influence of noise due to the sheet S, and a decrease in the accuracy of correction in the density unevenness correction processing based on the detection result, can be prevented. That is, according to the present embodiment, it is possible to improve correction accuracy in correction processing for correcting density unevenness in the sub-scanning direction occurring in an output image.

In the image forming apparatus 100 of the present embodiment, the test pattern (detection image) on the sheet S is read using the reader unit 100A configured to read an image of a document placed on the document table 102, but reading may also be performed by another method. For example, a density sensor for detecting density of an image formed on a sheet may be arranged further downstream in the conveyance direction than the image forming units P (downstream of the fixing apparatus 11) in a conveyance path where the sheet S is conveyed within the image forming apparatus 100. In that case, the test pattern (detection image) on the sheet S is read inline using the density sensor.

### Second Embodiment

In a second embodiment, an example in which the control unit 110 controls the sheet interval in the image forming operation for forming the test pattern in accordance with the number of sheets on which the test pattern is formed will be described. In the following, the description of parts common to the first embodiment will be omitted.

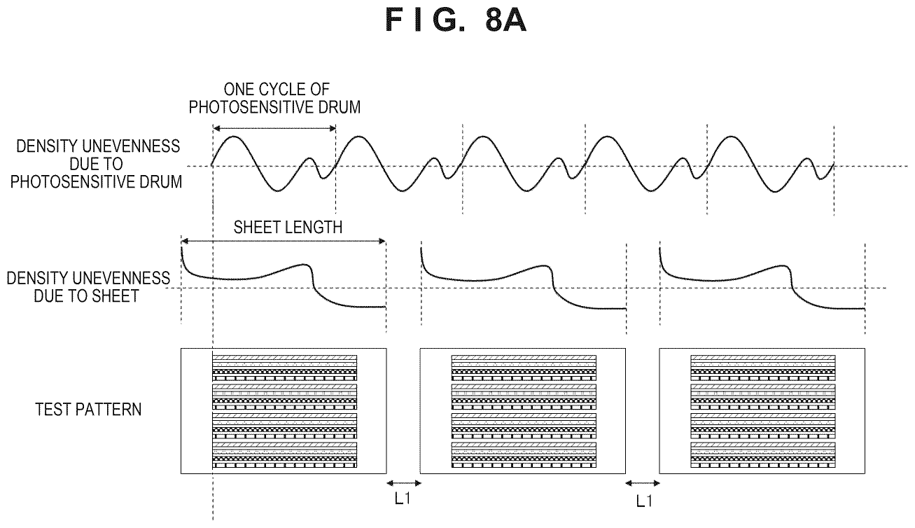

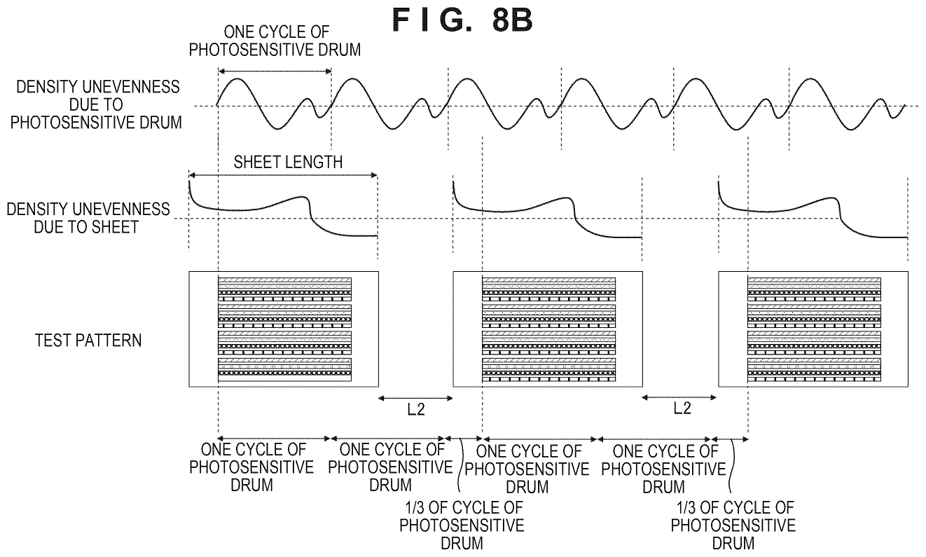

The image forming apparatus 100 of the present embodiment is configured to accept a designation of a number of sheets S (the number of output sheets) on which the test pattern is to be formed, from the user via the operation unit 20. FIGS. 8A and 8B illustrate examples of setting a sheet interval for that image forming operation for forming the test pattern, used when three sheets S are designated as the number of sheets S. FIG. 8A illustrates an example in which the sheet interval L1 set in a normal image forming operation is used as the sheet interval for the image forming operation for forming the test pattern. Meanwhile, FIG. 8B illustrates an example in which the sheet interval L2 is used as the sheet interval for the image forming operation for forming the test pattern.

As illustrated in FIG. 8B, the control unit 110 controls the sheet interval L2 in the image forming operation for forming the test pattern such that its interval differs from the sheet interval L1 in a normal image forming operation. At that time, the control unit 110 controls the sheet interval L2 such that an interval between the writing start position of the test pattern formed on a preceding sheet S and the writing start position of the test pattern formed on a next sheet S in the sub-scanning direction equals a sum of an integer multiple of the circumference of the photosensitive drum 1 and a value obtained by dividing that circumference by the number of sheets S (such that the interval is included in a range that is ±2.5% relative to that sum).

With this, as illustrated in FIG. 8B, the phase of periodic changes (noise) appearing in density data due to the sheet S can be reliably shifted from the phase of periodic changes (density unevenness) appearing in density data due to the photosensitive drum 1. In this state, for example, averaging processing for averaging a detection result of density unevenness corresponding to a phase corresponding to one rotation cycle of the photosensitive drum obtained from the first sheet S and a detection result of density unevenness corresponding to a phase corresponding to one rotation cycle of the photosensitive drum obtained from the second sheet S is performed. With this averaging processing, the influence of noise occurring due to the sheet S can be reduced (or suppressed). As a result, it is possible to improve accuracy of detecting density unevenness due to the photosensitive drum 1.

### Third Embodiment

In a third embodiment, an example in which the control unit 110 controls the sheet interval in the image forming operation for forming the test pattern in accordance with a type of sheet on which the test pattern is formed will be described. In the following, the description of parts common to the first embodiment will be omitted.

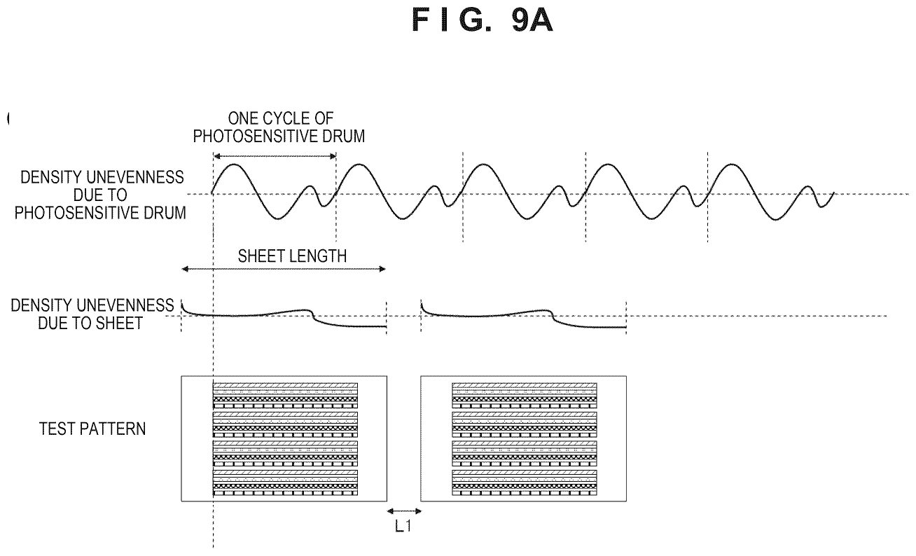

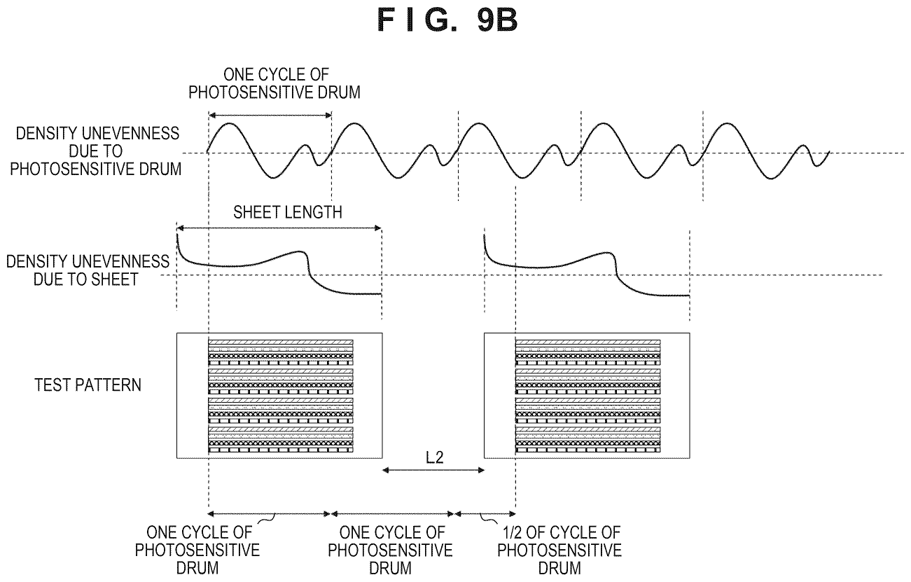

The image forming apparatus 100 of the present embodiment is configured to accept a designation of a type of sheet S on which the test pattern is to be formed, from the user via the operation unit 20. FIG. 9A illustrates an example of setting a sheet interval, used when a sheet with a grammage below a threshold is designated as a type of sheet S on which the test pattern is to be formed. In this case, the sheet interval in the image forming operation for forming the test pattern is set to the sheet interval L1. When a sheet with a small grammage is used for outputting the test pattern, shocks are less likely to occur when the sheet enters or exits the secondary transfer portion T2, for example. Therefore, density unevenness in the sub-scanning direction due to the sheet S is less likely to occur in an output image. Accordingly, when such a type of sheet is used, the control unit 110 uses the sheet interval L1 in a normal image forming operation as the sheet interval, and thereby shortens the time required for density unevenness correction processing.

Meanwhile, FIG. 9B illustrates an example of setting a sheet interval, used when a sheet with a grammage greater than or equal to the threshold is designated as a type of sheets S on which the test pattern is to be formed. When such a type of sheet is used, the control unit 110 uses the sheet interval L2 as the sheet interval, as illustrated in FIG. 9B. With this, the control unit 110 controls the sheet interval L2 in the image forming operation for forming the test pattern such that its interval differs from the sheet interval L1 in a normal image forming operation. At that time, similarly to the second embodiment, the control unit 110 controls the sheet interval L2 such that an interval between the writing start position of the test pattern formed on a preceding sheet S and the writing start position of the test pattern formed on a next sheet S in the sub-scanning direction equals a sum of an integer multiple of the circumference of the photosensitive drum 1 and a value obtained by dividing that circumference by the number of sheets S.

With this, as illustrated in FIG. 9B, the phase of noise occurring due to the sheet S can be reliably shifted from the phase of density unevenness due to the photosensitive drum 1. In this state, for example, averaging processing for averaging density data corresponding to a phase corresponding to one rotation cycle of the photosensitive drum obtained from the first sheet S and density data corresponding to a phase corresponding to one rotation cycle of the photosensitive drum obtained from the second sheet S is performed. With this averaging processing, the influence of noise occurring due to the sheet S can be reduced (or suppressed). As a result, it is possible to improve accuracy of detecting density unevenness due to the photosensitive drum 1.

According to the present disclosure, it is possible to improve correction accuracy in correction processing for correcting density unevenness in the sub-scanning direction occurring in an output image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-175260, filed Oct. 4, 2024, and Japanese Patent Application No. 2025-154767, filed Sep. 18, 2025, which are hereby incorporated by reference herein in their entirety.

What is claimed is:

1. An image forming apparatus comprising:
an image forming unit configured to form an image;
a conveyance unit configured to convey a sheet on which a test image has been formed by the image forming unit;
a sensor configured to read the test image on the sheet, while the sheet is being conveyed by the conveyance unit; and
a controller configured to:
cause the image forming unit to form a test image on each of a first sheet and a second sheet succeeding the first sheet; and
based on a reading result of the test image on the first sheet read by the sensor and a reading result of the test image on the second sheet read by the sensor, suppress density unevenness, in a conveyance direction in which the sheet is conveyed, of the image to be formed by the image forming unit.

2. The image forming apparatus according to claim 1, wherein
the image forming unit forms an electrostatic latent image on a cylindrical photosensitive member while rotating the photosensitive member, and develops the electrostatic latent image on the photosensitive member, and
an interval between a writing start position, in the conveyance direction, of the test image to be formed on the first sheet and a writing start position, in the conveyance direction, of the test image to be formed on the second sheet differs from an integer multiple of a circumference of the photosensitive member.

3. The image forming apparatus according to claim 2, wherein
the interval is included in a range that is ±2.5% relative to a sum of the integer multiple of the circumference of the photosensitive member and ½ of that circumference.

4. The image forming apparatus according to claim 2, wherein
the controller is configured to:
determine a first reading value for each of a plurality of regions in a rotation direction of the photosensitive member from the reading result of the test image on the first sheet;
determine a second reading value for each of the plurality of regions from the reading result of the test image on the second sheet; and
based on an average for each of the plurality of regions, which is determined from the first reading value and the second reading value, generate a control parameter for suppressing the density unevenness.

5. The image forming apparatus according to claim 2, wherein
the controller is further configured to control a distance between the first sheet and the second sheet such that the interval differs from the integer multiple of the circumference of the photosensitive member.

6. The image forming apparatus according to claim 5, wherein
the controller controls the distance based on a type of sheet on which the test image is to be formed.

7. The image forming apparatus according to claim 1, wherein
the image forming unit forms an electrostatic latent image on a cylindrical photosensitive member while rotating the photosensitive member, and develops the electrostatic latent image on the photosensitive member,
the controller suppresses the density unevenness based on a reading result of test images on a plurality of sheets read by the sensor, the plurality of sheets including the first sheet and the second sheet and a third sheet succeeding the second sheet, and
an interval between writing start positions of the test images formed on the plurality of respective sheets differs from an integer multiple of a circumference of the photosensitive member.

8. The image forming apparatus according to claim 7, wherein
the interval is included in a range that is ±2.5% relative to a sum of the integer multiple of the circumference of the photosensitive member and a value obtained by dividing that circumference by the number of a plurality of sheets.

9. The image forming apparatus according to claim 7, wherein
the controller is further configured to control a distance between the plurality of sheets such that the interval differs from the integer multiple of the circumference of the photosensitive member.

10. The image forming apparatus according to claim 9, wherein
the controller controls the distance based on a type of sheet on which the test image is to be formed.

11. The image forming apparatus according to claim 1, wherein
the test image is an image formed with uniform density.

12. The image forming apparatus according to claim 1, wherein
the image forming unit includes a fixing unit configured to fix the image to the sheet, and
the sensor is arranged downstream of the fixing unit in the conveyance direction.
